(19) United States
(12) Patent Application Publication
(10) Pub. No.: US 2022/0245547 A1
(43) Pub. Date: Aug. 4, 2022

(54) METHOD FOR PROVIDING INFORMATION ON WHETHER AN ITEM CAN BE ORDERED AND APPARATUS THEREOF

(71) Applicant: Coupang Corp., Seoul (KR)

(72) Inventors: Young Shin Kang, Seoul (KR); Hye Joon Cha, Seoul (KR); Hong Gyem Kim, Seoul (KR); Dae Jin Moon, Seoul (KR); Do Young Kim, Seoul (KR)

(21) Appl. No.: 17/322,568

(22) Filed: May 17, 2021

(30) Foreign Application Priority Data
Feb. 3, 2021 (KR) 10-2021-0015620

(51) Int. Cl. G06Q 10/06; G06Q 10/08; G06Q 30/06

(52) U.S. Cl. CPC G06Q 10/06315; G06Q 30/016; G06Q 30/0623; G06Q 10/087

(57) ABSTRACT

According to an embodiment, a method of providing information on whether an item is available for order includes receiving first information indicating whether items are available for order from a vendor device, receiving second information for requesting to check whether an item is available for order from an orderer device, identifying the item to be checked for order availability on the basis of the second information, determining whether the item is available for order on the basis of the first information and the second information, generating third information indicating whether the item is available for order on the basis of the determination of whether the item is available for order, and transmitting the third information to the orderer device in response to the second information. An embodiment provides a device for providing information on whether an item is available for order. An embodiment provides a computer-readable recording medium on which a computer program for executing the method of providing information on whether an item is available for order is recorded.

### BACKGROUND

### Technical field

The present disclosure relates to a method and apparatus for managing inventory of items in consideration of various pieces of information such as whether it is necessary to install the items, stock quantity by region, a resource for installing the items, and inventory of sub-items.

### Description of the Related Art

As e-commerce has been implemented in earnest, numerous users purchase items via the Internet, and various tasks may be performed by workers in the process of loading items into a warehouse and moving the items for sale and shipment.

To manage items loaded into a warehouse, information on the stock quantity of items is basically necessary. According to the related art, inventory is managed by simply providing information on the quantity of items being sold to sellers and the like.

Recently, however, it is increasingly necessary to manage inventory in consideration of various situations, such as the quantity of items to be sold and a sales type, beyond the level of item management of simply selling and delivering a single item.

As an example, when an item purchased by a consumer is one package including a plurality of sub-items, it is also necessary to manage inventory of the sub-items related to the ordered item.

As another example, when additional a resource other than a delivery worker is necessary, such as a case in which a consumer wants an installation worker for installation work in addition to delivery of an item purchased by the consumer, it is necessary to manage inventory in consideration of whether there is available additional a resource.

### SUMMARY

### Technical Goals

An aspect of the present disclosure is directed to providing information on whether an item is available for order and managing inventory in consideration of various pieces of information related to the item.

Another aspect of the present disclosure is directed to comprehensively managing inventory on the basis of various pieces of external information by receiving the various pieces of information required for comprehensive inventory management from external companies.

Goals which may be derived from the following example embodiments are not limited to those described above, and other goals which have not been described and merits may be understood from the following description and may be understood more clearly from the example embodiments. Also, it will be easy to see that the goals and merits which may be derived from the example embodiments can be implemented by means stated in the claims and combinations thereof.

### Technical Solutions

According to an aspect, a method of providing information on whether an item is available for order includes receiving first information indicating whether the item is available for order from a vendor device, receiving second information for requesting to check order availability from an orderer device, identifying the item to be checked for order availability on the basis of the second information, determining whether the item is available for order on the basis of the first information and the second information, generating third information indicating whether the item is available for order on the basis of the determination of whether the item is available for order, and transmitting the third information to the orderer device in response to the second information.

The receiving of the second information from the orderer may include, when the item includes a plurality of sub-items, receiving the second information indicating whether the plurality of sub-items are available for order from the orderer device.

The receiving of the first information from the vendor may include receiving the first information including whether each of the plurality of sub-items is available for order from the vendor device.

The determining of whether the item is available for order may include, when at least one of the plurality of sub-items is determined to be unavailable for order, determining that the item is unavailable for order.

The method may further include, when at least one of the plurality of sub-items is determined to be unavailable for order, transmitting information related to the sub-item, which is determined to be unavailable for order, to at least one of the orderer device and the vendor device.

The generating of the third information may include, when at least one of the plurality of sub-items is determined to be unavailable for order, generating the third information including information indicating that the item is unavailable for order.

Whether the order availability may include at least one of whether the item related to the second information is in stock and whether it is possible to deliver the item at a certain time point related to the second information.

When the item requires additional work other than delivery, the order availability may include whether it is possible to assign a resource for the additional work to a destination of the item at a certain time point related to the second information.

When the item requires the additional work other than delivery, whether the item is available for order may include whether the item is in stock in an area related to the destination of the item, and inventory of the item may be managed in units of predetermined areas.

According to another aspect, a device for providing information on whether an item is available for order includes a transceiver and a processor. The processor controls the transceiver to receive first information indicating whether the item is available for order from a vendor device, controls the transceiver to receive second information for requesting to check order availability from an orderer device, identifies the item to be checked for order availability on the basis of the second information, determines whether the item is available for order on the basis of the first information and the second information, generates third information indicating whether the item is available for order on the basis of the determination of whether the item is available for order, and controls the transceiver to transmit the third information to the orderer device in response to the second information.

When the item includes a plurality of sub-items, the processor may control the transceiver to receive the second information indicating whether the plurality of sub-items are available for order from the orderer device.

The processor may control the transceiver to receive the first information including whether each of the plurality of sub-items is available for order from the vendor device.

When at least one of the plurality of sub-items is determined to be unavailable for order, the processor may determine that the item is unavailable for order.

When at least one of the plurality of sub-items is determined to be unavailable for order, the processor may control the transceiver to transmit information related to the sub-item, which is determined to be unavailable for order, to at least one of the orderer device and the vendor device.

When at least one of the plurality of sub-items is determined to be unavailable for order, the processor may generate the third information including information indicating that the item is unavailable for order.

Whether the item is available for order may include at least one of whether the item related to the second information is in stock and whether it is possible to deliver the item at a certain time point related to the second information.

When the item requires additional work other than delivery, whether the item is available for order may include whether it is possible to assign a resource for the additional work to a destination of the item at a certain time point related to the second information.

When the item requires the additional work other than delivery, whether the item is available for order may include whether the item is in stock in an area related to the destination of the item, and inventory of the item may be managed in units of predetermined areas.

According to still another aspect of the present disclosure, a program for executing the above-described method is recorded on a computer-readable recording medium.

### Effects

According to various example embodiments provided in the present disclosure, it is possible to comprehensively manage inventory in consideration of various pieces of information related to items.

In addition to the above effect, specific derivable effects will be described together with details for implementing the invention.

### BRIEF DESCRIPTION OF THE DRAWINGS

FIG. 1 is a block diagram of a device for providing information on whether an item is available for order according to an example embodiment.

FIG. 2 is a diagram illustrating relationships between a seller, an orderer, and a vendor who are connected to each other in a process of ordering an item according to an example embodiment.

FIG. 3 is a flowchart illustrating a method of providing information on whether an item is available for order according to an example embodiment.

FIG. 4 is a sequential diagram illustrating the flow of information transmitted and received and processed between an orderer device, a seller device, and a vendor device in a process of performing the method according to an example embodiment.

FIGS. 5 and 6 are sequential diagrams illustrating the flow of information transmitted and received and processed between an orderer device, a seller device, and a vendor device according to an example embodiment when it is requested to determine whether an item including a plurality of sub-items is available for order.

FIG. 7 is a sequence diagram illustrating a method of providing information on whether an item is available for order in consideration of a time point at which an ordered item may be delivered and/or a time point at which additional work may be performed for the ordered item according to an example embodiment.

### DETAILED DESCRIPTION

Hereinafter, example embodiments of the present disclosure will be described in detail so that those of ordinary skill in the art may readily implement the embodiments. The embodiments may be implemented in many different forms and are not limited to those set forth herein.

The element suffixes “part” and “unit” used in the following description are given or used interchangeably by only considering the ease of creating the specification and do not have distinct meanings or roles by themselves.

Parts not related to description are omitted for clear description, and like reference numerals denote like elements throughout the specification. Some embodiments will be described in detail with reference to exemplary drawings. In assigning reference numerals to elements in each drawing, like reference numerals may denote like elements even though the like elements are shown in different drawings. When it is determined that a detailed description of a known structure or function relating to the present disclosure may obscure the gist of the example embodiments, the detailed description may be omitted.

To describe elements of the example embodiments, the terms such as “first,” “second,” “A,” “B,” “(a),” and “(b)” may be used. However, such terms are used merely to distinguish a particular element from another element, and the essence, order, sequence, number, etc. of the relevant elements are not limited by the terms. It will be understood that when an element is referred to as being “connected,” “coupled,” or “linked” to another element, the elements may be directly connected, coupled, or linked to each other, another element may be “interposed” between the elements, or the elements may be “connected,” “coupled,” or “linked” to each other via another element.

In the present disclosure, the terms such as “include,” “comprise,” and “have” indicate the presence of features, numbers, steps, operations, elements, parts described herein, or combinations thereof. Accordingly, it is to be understood that the possibility of the presence or addition of one or more other features, numbers, steps, operations, elements, parts, or combinations thereof is not precluded.

In implementing the present disclosure, elements may be subdivided and described for the purpose of convenience of description. However, these elements may be embodied in one device or module, or one element may be divided and embodied in two or more devices or modules.

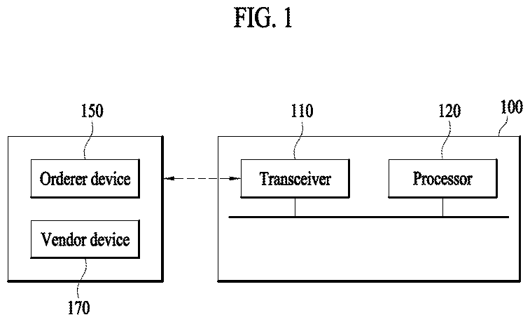

FIG. 1 is a block diagram of a device 100 for providing information on whether an item is available for order according to an example embodiment.

According to the example embodiment, the device 100 may include a transceiver 110 and a processor 120. According to the example embodiment, the transceiver 110 is configured to perform a process in which the device 100 exchanges certain information with external other devices. According to the example embodiment, communication technology used by the transceiver 110 to transmit and receive information may include mobile communication (GSM), code division multiple access (CDMA), long term evolution (LTE), fifth generation (5G), wireless local area network (WLAN), wireless fidelity (Wi-Fi), Bluetooth™, radio frequency identification (RFID), infrared data association (IrDA), ZigBee, near field communication (NFC), and the like.

According to the example embodiment, the processor 120 may be included in the device 100 and configured to control various elements included in the device 100 so that various embodiments to be implemented by the device 100 may be performed. According to the example embodiment, the transceiver 110 may be configured to transmit and receive the certain information under the control of the processor 120.

According to the example embodiment, the processor 120 may be configured to control the transceiver 110 to receive first information indicating whether items are available for order from a vendor device 170, configured to control the transceiver 110 to receive second information for requesting to check whether an item is available for order from an orderer device 150, configured to identify the item to be checked for order availability on the basis of the second information, configured to determine whether the item is available for order on the basis of the first information and the second information, configured to generate third information indicating whether the item is available for order on the basis of the determination of whether the item is available for order, and configured to control the transceiver 110 to transmit the third information to the orderer device 150 in response to inventory check request information.

According to the example embodiment, the processor 120 may include at least one of a random access memory (RAM), a read only memory (ROM), a central processing unit (CPU), a graphics processing unit (GPU), or a bus, which may be connected to each other. According to the example embodiment, the processor 120 may be configured to access a memory included in the device 100 and perform various operations using various types of programs, data, and certain information stored in the memory.

According to the example embodiment, the device 100 may be configured to perform various operations in connection with additional hardware which is added to the configuration shown in FIG. 1. According to the example embodiment, the device may further include a memory which is configured to store information transmitted and received by the transceiver 110. According to the example embodiment, the device 100 may include (or may be wired or wirelessly connected to) a display which is configured to display certain information under the control of the processor 120. The processor 120 may output at least some of various pieces of information transmitted and received in the example embodiment of the present disclosure to the display, and an administrator may receive the information transmitted and received in connection with a terminal of a worker.

According to the example embodiment, when an order is made by the orderer device 150, the device 100 may manage and track information related to the order in real time using the Bifrost platform so that a delivery process that meets certain condition(s) (e.g., delivery on a date and/or at a time requested by an orderer and/or additional work such as installation work) may be performed.

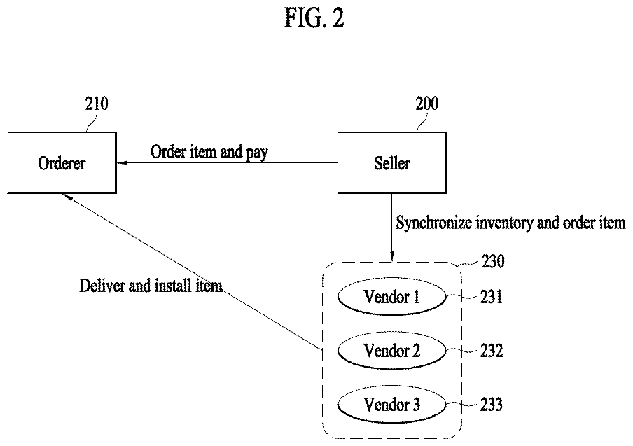

FIG. 2 is a diagram illustrating relationships between a seller 200, an orderer 210, and a vendor 230 who are connected to each other in a process of ordering an item according to an example embodiment.

According to the example embodiment, the seller 200, the orderer 210, and the vendor 230 of FIG. 2 may correspond to the device 100, the orderer device 150, and the vendor device 170 shown in FIG. 1, respectively. According to the example embodiment, the seller 200 may provide certain information to the orderer 210 in a process in which the orderer 210 orders an item. According to the example embodiment, the seller 200 may provide not only information on the item, such as a configuration and specifications of the item, but also various pieces of information related to an order procedure, such as delivery, installation, repair, return, and refund, to the orderer 210 so that the information may be displayed on the orderer device.

According to the example embodiment, in the process in which an order for a certain item is made, the seller 200 may provide various pieces of information related to inventory of items to the orderer 210. According to the example embodiment, the seller 200 may be requested by the orderer 210 to check whether an orderable item is available for order.

According to the example embodiment, the seller 200 may provide information on the stock quantity of orderable items and a date and/or a time at which a certain task (e.g., delivery, installation, or removal) for the ordered item may be performed to the orderer 210. According to the example embodiment, the orderer 210 may make an order and payment for an item on the basis of various pieces of received information.

According to the example embodiment, the seller 200 may transmit and receive certain information to and from the vendor 230 to acquire various pieces of information which will be provided to the orderer 210 in a process of ordering an item. According to the example embodiment, the seller 200 may acquire various pieces of information related to whether a certain item is available for order by communicating with the vendor 230. According to the example embodiment, the seller 200 may communicate with the vendor 230 to acquire information on inventory of items, information on a date and/or a time at which a certain task (e.g., delivery, installation, or removal) may be performed, and the like.

According to the example embodiment, the vendor 230 may include different types of vendors (e.g., vendors 231, 232, and 233), which may be identified as separate vendors through vendor identifiers in communication with the seller 200. According to the example embodiment, when the orderer 210 orders an item and pays for the item, the seller 200 may order the item from the vendor 230 on the basis of synchronized information on inventory and the like, and ordering information related to the item ordered by the orderer 210 may be transmitted to at least one of the plurality of vendors 231, 232, and 233 in the vendor 230. The at least one of the plurality of vendors 231, 232, and 233 receiving the ordering information may deliver the item to the orderer 210 and perform additional work (e.g., installation). According to the example embodiment, the seller 200 may receive information on a process of delivering the item from the at least one of the plurality of vendors 231, 232, and 233 and provide delivery-related information to the orderer 210 on the basis of the process information.

According to the related art, items are managed through such vendor identifiers in most cases. For this reason, it may be difficult to manage inventory of items. For example, in the case of managing inventory of items which are sold as packages including a plurality of sub-items (e.g., packages including a plurality of different sub-items (an order for an air conditioner including an air conditioner body and an outdoor unit, an order for an item package including a washing machine and a dryer, etc.) and packages including a plurality of identical sub-items (packages including a plurality of sub-items of the same kind which are separately sold)), inventory management based on vendor identifiers makes it difficult to accurately inventory sub-items. Further, when additional work other than delivery is required, inventory management based on vendor identifiers may not even be suitable for managing an additional work schedule for the additional work. Accordingly, in order to manage inventory of items including a plurality of sub-items and inventory of items which require additional work, it is necessary to favorably manage and process information transmitted and received in relation to the vendor 230.

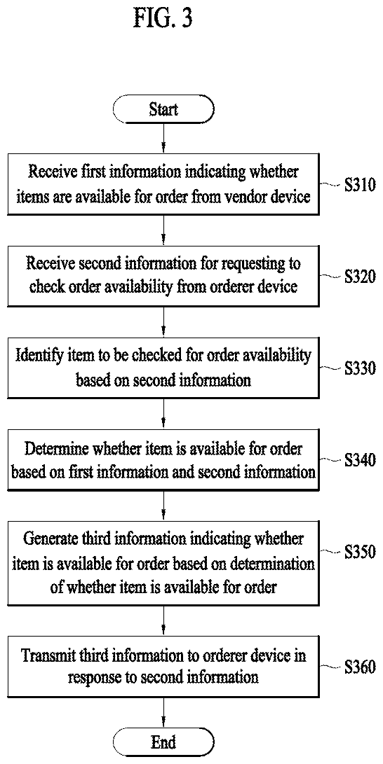

FIG. 3 is a flowchart illustrating a method of providing information on whether an item is available for order according to an example embodiment.

In operation S310, the device 100 may receive first information indicating whether items are available for order from the vendor device 170.

According to the example embodiment, the first information, which is received by the device 100 from the vendor device 170 and indicates whether the items are available for order, may include various pieces of information required for determining whether the items are available for order. For example, the first information may include various pieces of information such as inventory information of each item, item stock status by area, and whether it is possible to deliver the item and/or perform work other than delivery (e.g., installation, removal, repair, retrieval, return, and exchange) on a certain date. For convenience of description, it is assumed that whether an item is available for order represents whether delivery and/or various tasks other than delivery may be performed for the item.

According to the example embodiment, the information, which is received from the vendor device 170 and indicates whether the items are available for order, may include snapshot information of the vendor device 170. For example, information on a snapshot of stock movement between the vendor devices 170, a snapshot of stock movement between intracompany centers, etc. may be included in the first information as information indicating whether the items are available for order.

According to the example embodiment, whether items which may be ordered by the orderer device 150 are available for order may be synchronized between the device 100 and the vendor device 170 on the basis of the first information received from the vendor device 170. In other words, the device 100 synchronizes the information on whether the items are available for order with the vendor device 170 on the basis of the first information.

In operation S320, the device 100 may receive second information for requesting to check order availability from the orderer device 150. According to the example embodiment, in operation S330, the device 100 receiving the second information may identify the item to be checked for order availability on the basis of the second information. According to the example embodiment, the second information may include various pieces of information related to an order for the item. According to the example embodiment, the second information may include various pieces of information such as an identifier which may be used in identifying the item (e.g., an identifier used by a seller to manage the item), a serial number of the item, or a stock keeping unit (SKU) of the item), the quantity of items, the type of item, a destination of the item, additional work required for the item to be delivered, and the like.

In operation S340, according to the example embodiment, the device 100 may determine whether the item is available for order on the basis of the first information received from the vendor device 170 and the second information received from the orderer device 150. According to the example embodiment, the device 100 may determine and/or synchronize whether the items are available for order using the first information received from the vendor device 170, and when the second information is received from the orderer device 150 after whether the items are available for order is determined, the device 100 may determine whether the item to be checked for order availability is available for order on the basis of the second information. In other words, according to example embodiment, the device 100 may check whether the item to be ordered by the orderer is available for order using information which is synchronized with the vendor device 170 on the basis of the first information and relates to whether each item is available for order.

According to the example embodiment, in operation S350, the device 100 may generate third information, which is determined on the basis of the second information and relates to whether the item is available for order, on the basis of the determination of whether the item is available for order in operation S340. According to the example embodiment, the third information indicating whether the item is available for order may include stock status of the item which is identified on the basis of the second information, whether it is possible to deliver the item on a certain date (and/or time) and/or perform additional work other than delivery, and the like. According to the example embodiment, when the item to be checked for order availability includes a plurality of sub-items, the device 100 may generate third information indicating whether each of the plurality of sub-items is available for order.

In operation S360, according to the example embodiment, the device 100 may transmit the third information to the orderer device 150 in response to the second information. According to the example embodiment, the orderer device 150 transmitting the second information to the device 100 may acquire a response on whether the item is available for order by receiving the third information. According to the example embodiment, the orderer device 150 receiving the third information may display whether the item to be ordered is available for order on the basis of the third information. According to the example embodiment, the orderer may identify whether the item is available for order on the basis of the information displayed on the orderer device 150 and make an order and payment.

According to the example embodiment, the device 100 may transmit information on a template which may be used in a process of generating information (e.g., the first information) to be provided by an external company, such as the vendor device 170, to the device 100. According to the example embodiment, in the process of generating information to be provided to the device 100 on the basis of information on the template received from the device 100, the vendor device 170 may rapidly generate and provide accurate entries to the device 100. Accordingly, the device 100 may manage various pieces of information, which are received from external companies and generated in a predetermined manner, to collectively manage and process information received from various external companies.

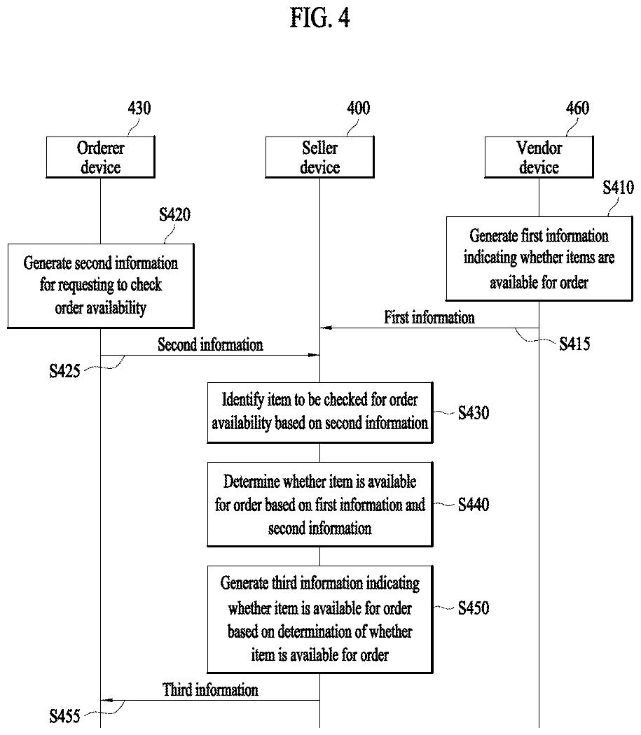

FIG. 4 is a sequential diagram illustrating the flow of information transmitted and received and processed between an orderer device 430, a seller device 400, and a vendor device 460 in a process of performing the method according to an example embodiment. According to the example embodiment, the seller device 400 of FIG. 4 may correspond to the device 100 of FIG. 1, and the orderer device 430 and the vendor device 460 may correspond to the orderer device 150 and the vendor device 170 of FIG. 2, respectively.

According to the example embodiment, the vendor device 460 may generate first information indicating whether items are available for order (S410). According to the example embodiment, the first information may include various pieces of information related to whether at least one item which may be sold through the seller device 400 is available for order.

According to the example embodiment, the seller device 400 may receive the first information from the vendor device 460. The seller device 400 may notify the orderer device 430 whether an item is available for order on the basis of the received first information.

According to the example embodiment, the orderer device 430 may generate second information for requesting to check order availability (S420). According to the example embodiment, the second information received from the orderer device 430 may be information for requesting to check whether at least one item is available for order. According to the example embodiment, a process in which the seller device 400 receives the second information from the orderer device 430 may be performed when a screen provided in an arbitrary process, in which an orderer makes an order for the item through the orderer device 430, is displayed.

According to the example embodiment, when the seller device 400 receives the second information (S425), the seller device 400 may identify the item to be checked for order availability on the basis of the second information (S430).

According to the example embodiment, the seller device 400 may determine whether the item is available for order on the basis of the first information indicating whether the items are available for order and the second information for requesting to check order availability (S440). According to the example embodiment, the item to be checked for order availability may include at least one item which may be sold through the seller device 400. According to the example embodiment, the seller device 400 may determine whether at least one sellable item is available for order and then generate third information indicating whether the item is available for order (S450). The third information generated according to the example embodiment may include whether the item which is requested to be checked for order availability through the second information is available for order among items which are sellable through the seller device 400 (whether there is stock available to order, whether it is possible to deliver the item and perform other work on an arbitrary date, etc.).

According to the example embodiment, the seller device 400 may transmit the third information to the orderer device 430, which transmits the second information, in response to the second information (S455). According to the example embodiment, the orderer device 430 receiving the third information may display information on whether the item to be ordered is available for order to the orderer on the basis of the third information.

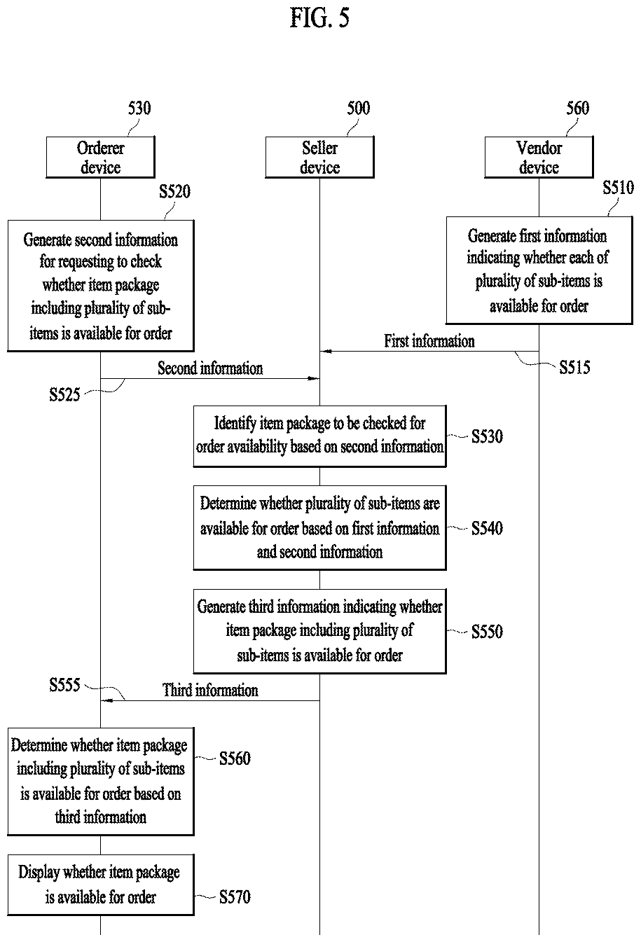

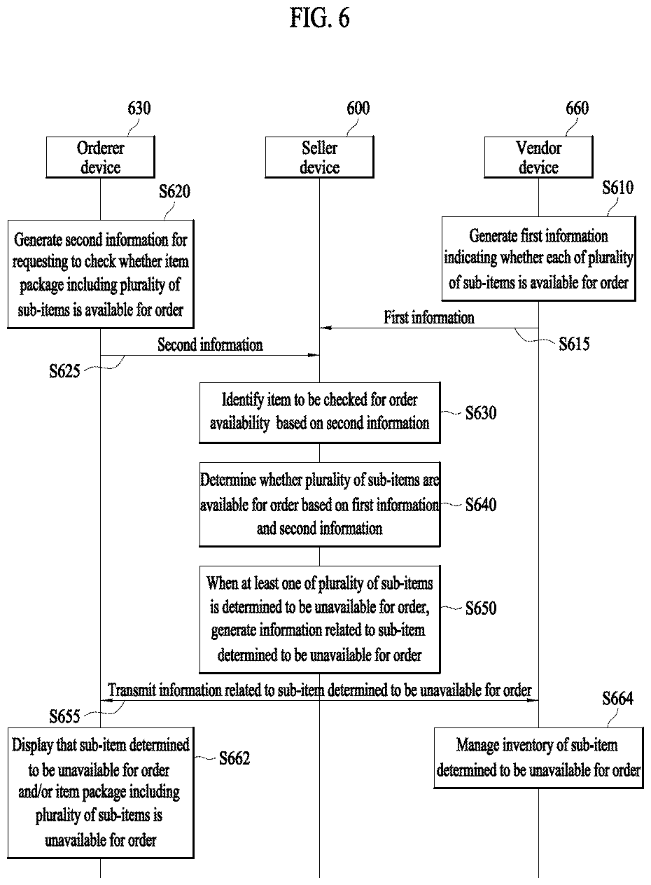

FIGS. 5 and 6 are sequential diagrams illustrating the flow of information transmitted and received and processed between an orderer device, a seller device, and a vendor device according to an example embodiment when it is requested to determine whether an item including a plurality of sub-items is available for order.

Referring to FIG. 5, a seller device 500 may provide information on whether an item including a plurality of sub-items (or a sub-item package) is available for order to an orderer device 530. According to the example embodiment, the seller device 500 of FIG. 5 may correspond to the device 100 of FIG. 1, and the orderer device 530 and a vendor device 560 may correspond to the orderer device 150 and the vendor device 170 of FIG. 2, respectively.

According to the example embodiment, the vendor device 560 may generate first information indicating whether each of a plurality of sub-items which may be sold through the seller device 500 is available for order (S510). An item package including a plurality of sub-items according to the example embodiment may be a package including different types of sub-items or a package including the same type of sub-items. According to the example embodiment, the first information may include information related to whether each of the plurality of sub-items is available for order and/or information related to whether an item package including the plurality of sub-items is available for order.

According to the example embodiment, the seller device 500 may receive the first information indicating whether each of the plurality of sub-items is available for order from the vendor device 560 (S515). The seller device 500 may notify the orderer device 530 whether an item is available for order on the basis of the received first information.

According to the example embodiment, the orderer device 530 may generate second information for requesting to check whether the item package including the plurality of sub-items is available for order (S520). According to the example embodiment, the second information may include information related to whether each of the plurality of sub-items is available for order and/or information related to whether the item package including the plurality of sub-items is available for order.

According to the example embodiment, the second information received from the orderer device 530 may be information for requesting to check whether at least one item package including the plurality of sub-items is available for order. According to the example embodiment, a process in which the seller device 500 receives the second information from the orderer device 530 may be performed when a screen provided in an arbitrary process, in which an orderer makes an order for an item through the orderer device 530, is displayed.

According to the example embodiment, when the seller device 500 receives the second information (S525), the seller device 500 may determine whether the item is available for order on the basis of the second information (S530). An item to be checked for order availability according to the example embodiment may be each of the plurality of sub-items or the item package including all the sub-items.

According to the example embodiment, the seller device 500 may determine whether the plurality of sub-items are available for order on the basis of the first information indicating whether the items are available for order and the second information for requesting to check whether the item is available for order (S540). According to the example embodiment, the determination of whether the plurality of sub-items are available for order may include a determination of whether each of the sub-items and/or the item package including the plurality of sub-items are/is available for order.

According to the example embodiment, the seller device 500 may determine whether the items are available for order and then generate third information indicating whether an item including the plurality of sub-items is available for order on the basis of the determination (S550). The third information generated according to the example embodiment may include whether the item package which is requested to be checked for order availability through the second information is available for order and/or whether the plurality of sub-items included in the item package are available for order (that is, whether the item package and/or the plurality of sub-items included in the item package are in stock and available for order, whether it is possible to deliver the item package and/or the sub-items and perform other work on an arbitrary date, etc.).

According to the example embodiment, the seller device 500 may generate third information of the item package on the basis of whether each of the plurality of sub-items included in the item package is available for order. According to the example embodiment, when even at least one of the plurality of sub-items is determined to be unavailable for order, the seller device 500 may generate third information indicating that the item package including the plurality of sub-items is unavailable for order.

According to the example embodiment, the seller device 500 may transmit the third information to the orderer device 530, which transmits the second information, in response to the second information (S555).

According to the example embodiment, the orderer device 530 may determine whether the item package including the plurality of sub-items is available for order on the basis of the third information (S560). According to the example embodiment, when the third information indicates that the item package including the plurality of sub-items is unavailable for order, it may be determined whether the item package is available for order according to the third information. For example, an air conditioner may be a package including an air conditioner body and an outdoor unit, and the orderer may request to check whether the item package referred to as “air conditioner” is available for order rather than whether each of the air conditioner body and the outdoor unit is available for order. Accordingly, the orderer device 530 may determine whether the item package including the plurality of sub-items is available for order on the basis of the third information on whether each of the plurality of sub-items is available for order and display the third information to the orderer.

According to the example embodiment, when the third information indicates whether each of the plurality of sub-items is available for order, at least one of the plurality of sub-items may be determined to be unavailable for order. In this case, the orderer device 530 the seller device 500 may determine that the item package including the plurality of sub-items is unavailable for order.

According to the example embodiment, the orderer device 530 receiving the third information may display information on whether the item package to be ordered is available for order to the orderer on the basis of the third information (S570).

According to the example embodiment, when the third information indicates whether the item package and/or the plurality of sub-items included in the item package are/is available for order, the orderer device 530 may display whether the item package and/or the plurality of sub-items included in the item package are/is available for order on the basis of the third information.

According to the example embodiment, referring to FIG. 6, when at least one of a plurality of sub-items is determined to be unavailable for order after whether an item package including the plurality of sub-items is available for order is determined, a seller device 600 may transmit information indicating that it is necessary to add the sub-item determined to be unavailable for order to an orderer device 630 and/or a vendor device 660. According to the example embodiment, seller device 600 of FIG. 6 may correspond to the device 100 of FIG. 1, and the orderer device 630 and a vendor device 660 may correspond to the orderer device 150 and the vendor device 170 of FIG. 2, respectively.

According to the example embodiment, characteristics of operations S610 to S640 of FIG. 6 may be identical or similar to those of operations S510 to S540 of FIG. 5, and thus detailed descriptions thereof are omitted.

According to the example embodiment, when at least one of the plurality of sub-items is determined to be unavailable for order, the seller device 600 may generate information related to the sub-item determined to be unavailable for order (S650). According to the example embodiment, the item package including the plurality of sub-items is available for order only when all of the plurality of sub-items are available for order. According to the example embodiment, the seller device 600 may determine a sub-item which is unavailable for order among the plurality of sub-items on the basis of first information received from the vendor device 660.

According to the example embodiment, the seller device 600 the information related to the sub-item determined to be unavailable for order may include information indicating the sub-item which is unavailable for order and/or information indicating that it is necessary to stock the sub-item determined to be unavailable for order.

According to the example embodiment, the seller device 600 may transmit the information related to the sub-item determined to be unavailable for order to the orderer device 630 and/or the vendor device 660 (S655).

According to the example embodiment, the seller device 600 may transmit the information related to the sub-item determined to be unavailable for order to the orderer device 630 in response to the second information. According to the example embodiment, the orderer device 630 may display that the sub-item determined to be unavailable for order and/or the item package including the plurality of sub-items is unavailable for order on the basis of the information related to the sub-item determined to be unavailable for order. According to the example embodiment, the item package including the at least one sub-item determined to be unavailable for order may be displayed to be unavailable for order. According to the example embodiment, the orderer device 630 may display each of one or more sub-items determined to be unavailable for order and thereby display relevant information to the orderer so that the orderer may separately order the sub-items (S662).

According to the example embodiment, the seller device 600 may transmit information related to the sub-item determined to be unavailable for order to the vendor device 660 such that inventory management may be adaptively performed between the seller device 600 and the vendor device 660 (S664). In other words, the vendor device 660 which receives the information related to the sub-item determined to be unavailable for order from the seller device 600 may prevent the sub-item from being determined to be unavailable for order through inventory management of the sub-item determined to be unavailable for order and/or expansion of a resource required for work such as delivery and the like.

According to the example embodiment, when the sub-item determined to be unavailable for order is changed to an orderable state, the vendor device 660 may transmit information indicating that the sub-item is changed to the orderable state to the seller device 600. According to the example embodiment, when the information indicating that the sub-item is changed to the orderable state, the seller device 600 may generate third information which indicates whether the plurality of sub-items are available for order to reflect the change and transmit the third information to the orderer device 630.

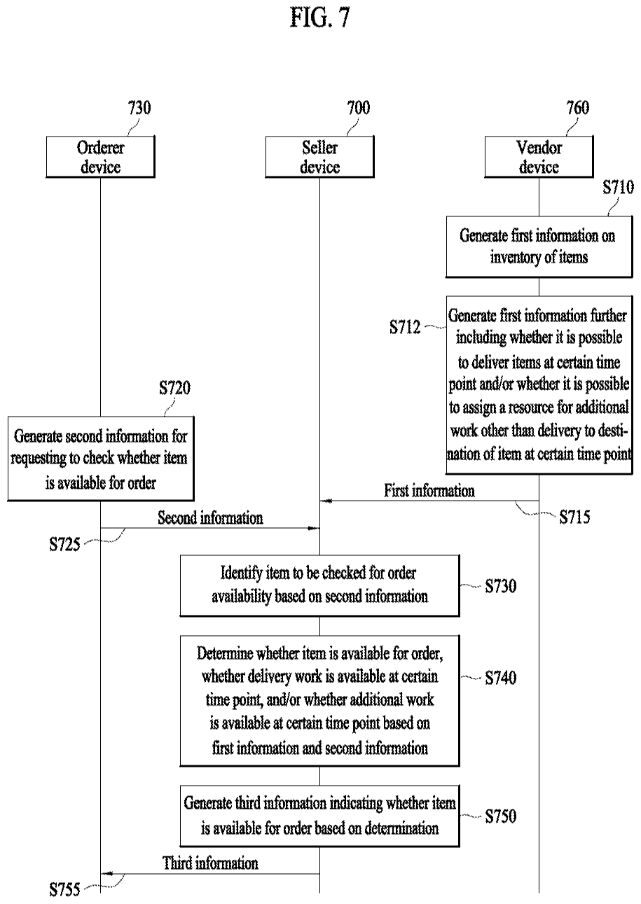

FIG. 7 is a sequence diagram illustrating a method of providing information on whether an item is available for order in consideration of a time point at which an ordered item may be delivered and/or a time point at which additional work may be performed for the ordered item according to an example embodiment.

According to the example embodiment, a seller device 700 of FIG. 7 may correspond to the device 100 of FIG. 1, and an orderer device 730 and a vendor device 760 may correspond to the orderer device 150 and the vendor device 170 of FIG. 2, respectively.

According to the example embodiment, the vendor device 760 may generate first information including information on inventory of items (S710). According to the example embodiment, the information on inventory of items includes the stock quantity, the stock location, and/or the like of each item which may be ordered by the orderer device 730.

According to the example embodiment, the vendor device 760 may generate first information which further includes whether it is possible to deliver the items at a certain time point and/or whether it is possible to assign a resource for additional work other than delivery work to a destination of the item at a certain time point (S712). According to the example embodiment, for delivery work and/or additional work other than delivery work, the vendor device 760 may separately manage inventory in an area related to a delivery address of an orderer and provide relevant information to the seller device 700. According to the example embodiment, the vendor device 760 may generate first information including whether it is possible to perform delivery work and/or additional work at the address of the orderer according to date and/or time. According to the example embodiment, information related to the address may be managed on the basis of information such as a zip code.

According to the example embodiment, the delivery work and the additional work may be designated by the orderer, and the supply of a resource required for the work should be confirmed to perform the work on a designated date. According to the example embodiment, the seller device 700 may receive the first information from the vendor device 760 and generate third information indicating whether the item is available for order on the basis of inventory of the items at a distribution center close to the address of the orderer and/or the supply of a resource for performing the work at the address. According to the example embodiment, inventory for work may be managed on the basis of regional distribution centers, and a resource for performing work may be separately assigned to each area. According to the example embodiment, the vendor device 760 and the seller device 700 may share various pieces of information through the first information including inventory information and/or the information related to the supply of a resource for work. According to the example embodiment, the information related to the supply of a resource for work may include holiday information for each company and/or each workforce of the company, schedule information for each workforce by date and/or time, and the like.

According to the example embodiment, when second information for requesting to check order availability is generated by the orderer device 730 (S720) and transmitted to the seller device 700 (S725), the seller device 700 may identify the item to be checked for order availability on the basis of the second information (S730). According to the example embodiment, the seller device 700 may determine whether the item is available for order, whether delivery work is available at a certain time point, and/or whether additional work is available at a certain time point on the basis of the first information and the second information (S740). According to the example embodiment, the seller device 700 may determine the item, the delivery address, etc. on the basis of the second information. According to the example embodiment, the seller device 700 may determine whether the item is in stock at a distribution center of an area corresponding to the destination and further determine whether delivery work for the item is available and/or whether the supply of a resource for performing additional work is available for the destination on the basis of the first information.

According to the example embodiment, based on the determination of operation S740, the seller device 700 may generate third information indicating whether it is possible to make an order (that is, whether the item is available for order, whether delivery work is available at the certain time point, and/or whether the additional work is available at the certain time point) (S750) and transmit the third information to the orderer device 730 (S755).

According to the example embodiment, the vendor device 760 may provide not only information on a current stock of the item but also information on the quantity of items scheduled to be stocked in the future to the seller device 700. According to the example embodiment, the vendor device 760 may additionally provide information on the quantity, scheduled warehousing date, etc. of items scheduled to be stocked in the future to the seller device 700, and the seller device 700 may provide the additional information to the orderer device 730 on the basis of the information received from the vendor device 760 in an ordering process. For example, the seller device 700 may provide not only information on the current stock quantity of items to be ordered through the orderer device 730 and a date on which delivery work and/or additional work is available to the orderer device 730 on the basis of the information received from the vendor device 760 but also provide information on a recommended schedule for the delivery work and/or the additional work to the orderer device 730 on the basis of the quantity of items to be stocked, a scheduled warehousing date, work schedule information, etc.

The above-described methods of the present disclosure may be recorded as a program to be executed on a computer and provided in a computer-readable recording medium. The methods of the present disclosure may be executed through software. When the methods are executed through software, elements of the present disclosure are code segments for performing necessary operations. The program or code segments may be stored in a processor-readable recording medium.

The computer-readable recording medium includes all types of recording media in which data readable by a computer system is stored. Examples of the computer-readable recording medium are a ROM, a RAM, a compact disc (CD)-ROM, a digital versatile disc (DVD), a DVD-RAM, magnetic tape, a floppy disk, a hard disk, an optical data storage device, and the like. The computer-readable recording medium can also be distributed over computer systems connected via a network such that a computer-readable code can be stored and executed in a distributed manner.

From the above description of the present disclosure, those of ordinary skill in the art can make various substitutions, modifications, and variations without departing from the technical spirit of the present disclosure. Accordingly, the present disclosure is not limited to the above-described example embodiments and the accompanying drawings.

1. A method for providing information on whether an item is available for order, the information provided by an electronic device comprising a transceiver, a memory, and a processor, the method comprising:
receiving, via the transceiver over a network, first information indicating whether the item is available for order from a vendor device, the item comprising a plurality of sub-items;
synchronizing, via the processor, which of a plurality of items including the item are available for order between the electronic device and the vendor device based on the first information;
receiving, via the transceiver over the network, second information for requesting to check order availability from an orderer device, the second information being indicative of whether the plurality of sub-items are available for order from the orderer device, the second information indicative of an address associated with the orderer device;
identifying, via the processor, the item to be checked for order availability based on the second information, wherein, when the item requires additional work other than delivery, the order availability comprises whether the item is in stock in an area related to the address and whether it is possible to perform delivery work and/or the additional work at the address and at a certain time point related to the second information;
determining, via the processor, whether the item is available for order based on the first information and the second information;
determining, via the processor, whether at least one resource for work on the sub-items is available within a defined distance of the address associated with the orderer device;
generating, via the processor, third information indicating whether the item is available for order based on the determination of whether the item is available for order, the third information comprising information regarding availability of the at least one resource for work on the sub-items;
transmitting, via the transceiver over the network, the third information to the orderer device in response to the receiving of the second information, wherein transmitting, via the transceiver over the network, the third information comprises, when the delivery work and/or the additional work cannot be performed, transmitting, to the orderer device, information on a recommended schedule for the delivery work and/or the additional work to the orderer device based on at least one of a quantity of the item to be stocked, a scheduled warehousing date of the item, and work schedule information on the additional work;
performing the delivery work of the item to the address based on the third information; and
performing the additional work at the address based on the third information.

2. (canceled)

3. The method of claim 1, wherein the receiving of the first information from a vendor comprises receiving the first information including whether each of the plurality of sub-items is available for order from the vendor device.

4. The method of claim 3, wherein the determining of whether the item is available for order comprises, when at least one of the plurality of sub-items is determined to be unavailable for order, determining that the item is unavailable for order.

5. The method of claim 4, further comprising, when at least one of the plurality of sub-items is determined to be unavailable for order, transmitting information related to a sub-item determined to be unavailable for order to at least one of: the orderer device or the vendor device.

6. The method of claim 5, wherein the generating of the third information comprises, when at least one of the plurality of sub-items is determined to be unavailable for order, generating the third information including information indicating that the item is unavailable for order.

7. The method of claim 1, wherein the order availability comprises at least one of: whether the item related to the second information is in stock or whether delivery of the item is possible at a certain time point related to the second information.

8. (canceled)

9. (canceled)

10. A device for providing information on whether an item is available for order, the device comprising:
a transceiver configured to communicate with a vendor device and an orderer device over a network;
a processor; and
a memory having stored thereon instructions that, when executed on the processor, cause the processor to:
control the transceiver to receive, over the network, first information indicating whether the item is available for order from the vendor device, the item comprising a plurality of sub-items,
synchronize which of a plurality of items including the item are available for order between the electronic device and the vendor device based on the first information,
control the transceiver to receive, over the network, second information for requesting to check order availability from an orderer device, the second information being indicative of whether the plurality of sub-items are available for order from the orderer device, the second information indicative of an address associated with the orderer device,
identify the item to be checked for order availability based on the second information, wherein, when the item requires additional work other than delivery, the order availability comprises whether the item is in stock in an area related to the address and whether it is possible to perform delivery work and/or the additional work at the address and at a certain time point related to the second information,
determine whether the item is available for order based on the first information and the second information,
determine whether at least one resource for work on the sub-items is available within a defined distance of the address associated with the orderer device;
generate third information indicating whether the item is available for order based on the determination of whether the item is available for order, the third information comprising information regarding availability of the at least one resource for work on the sub-items, and
control the transceiver to transmit, over the network, the third information to the orderer device in response to the receiving of the second information
wherein transmitting, via the transceiver over the network, the third information comprises, when the delivery work and/or the additional work cannot be performed, transmitting, to the orderer device, information on a recommended schedule for the delivery work and/or the additional work to the orderer device based on at least one of a quantity of the item to be stocked, a scheduled warehousing date of the item, and work schedule information on the additional work,
wherein the delivery work of the item to the address is performed based on the third information, and
wherein the additional work at the address is performed based on the third information.

11. (canceled)

12. The device of claim 10, wherein the processor is configured to control the transceiver to receive the first information comprising whether each of the plurality of sub-items is available for order from the vendor device.

13. The device of claim 12, wherein, when at least one of the plurality of sub-items is determined to be unavailable for order, the processor is configured to determine that the item is unavailable for order.

14. The device of claim 13, wherein, when at least one of the plurality of sub-items is determined to be unavailable for order, the processor is further configured to control the transceiver to transmit information related to a sub-item determined to be unavailable for order to at least one of: the orderer device or the vendor device.

15. The device of claim 14, wherein, when at least one of the plurality of sub-items is determined to be unavailable for order, the processor is configured to generate the third information including information indicating that the item is unavailable for order.

16. The device of claim 10, wherein the order availability comprises at least one of: whether the item related to the second information is in stock or whether delivery of the item is possible at a certain time point related to the second information.

17. (canceled)

18. (canceled)

19. A non-transitory computer-readable recording medium having stored thereon instructions that, when executed by a processor of an electronic device, cause the processor to:
control a transceiver to receive, over a network, first information indicating whether an item is available for order from a vendor device, the item comprising a plurality of sub-items,
synchronize which of a plurality of items including the item are available for order between the electronic device and the vendor device based on the first information,
control the transceiver to receive, over the network, second information for requesting to check order availability from an orderer device, the second information being indicative of whether the plurality of sub-items are available for order from the orderer device, the second information indicative of an address associated with the orderer device,
identify the item to be checked for order availability based on the second information, wherein, when the item requires additional work other than delivery, the order availability comprises whether the item is in stock in an area related to the address and whether it is possible to perform delivery work and/or the additional work at the address and at a certain time point related to the second information,
determine whether the item is available for order based on the first information and the second information,
determine whether at least one resource for work on the sub-items is available within a defined distance of the address associated with the orderer device;
generate third information indicating whether the item is available for order based on the determination of whether the item is available for order, the third information comprising information regarding availability of the at least one resource for work on the sub-items, and
control the transceiver to transmit, over the network, the third information to the orderer device in response to the receiving of the second information
wherein transmitting, via the transceiver over the network, the third information comprises, when the delivery work and/or the additional work cannot be performed, transmitting, to the orderer device, information on a recommended schedule for the delivery work and/or the additional work to the orderer device based on at least one of a quantity of the item to be stocked, a scheduled warehousing date of the item, and work schedule information on the additional work,
wherein the delivery work of the item to the address is performed based on the third information, and
wherein the additional work at the address is performed based on the third information.

20. The method of claim 1, wherein the additional work comprises installing the item at the address.

21. The method of claim 21, wherein the plurality of sub-items comprise at least one sub-item used for the installation of the item.

22. The method of claim 1, wherein the additional work comprises at least one of the following: installation, removal, repair, retrieval, return, and exchange.
